(19) United States
(12) Patent Application Publication
(10) Pub. No.: US 2017/0023311 A1
(43) Pub. Date: Jan. 26, 2017

(54) Enhanced Heat Transfer In Plate-Fin Heat Exchangers

(71) Applicant: Nicholas F. URBANSKI, Katy, TX (US)

(72) Inventor: Nicholas F. URBANSKI, Katy, TX (US)

(21) Appl. No.: 15/147,158

(22) Filed: May 5, 2016

Related U.S. Application Data
(60) Provisional application No. 62/196,715, filed on Jul. 24, 2015.

(51) Int. Cl. F28F 3/04; F28F 3/10; F28F 13/08; F28D 9/00

(52) U.S. Cl. CPC F28F 3/04; F28D 9/0037; F28F 3/10; F28F 13/08; F28F 2255/00; B33Y 10/00

(57) ABSTRACT

This disclosure includes a heat exchanging apparatus, comprising a heat exchanger plate comprising a plurality of flow passages, and wherein each flow passage comprises at least one surface feature configured to change the flow characteristics of a linear flow along an axis of flow for the flow passage. The disclosure further includes a method of constructing a heat exchanger, comprising using additive manufacturing to form a first plate having a plurality of flow passages, wherein each of the flow passages has one or more integral surface features, wherein the integral surface features are configured to change the flow characteristics of a fluid flowed linearly along an axis of flow for the flow passage.

### CROSS REFERENCE TO RELATED APPLICATIONS

This application claims the priority benefit of U.S. Patent Application 62/196,715 filed Jul. 24, 2015 entitled ENHANCED HEAT TRANSFER IN PLATE-FIN HEAT EXCHANGERS, the entirety of which is incorporated by reference herein.

### TECHNOLOGICAL FIELD

Exemplary embodiments described herein pertain to three dimensional (3D) printing/additive manufacturing. More specifically, some exemplary embodiments described herein apply 3D printing/additive manufacturing to change the heat transfer and/or flow characteristics of plate-fin heat exchangers.

### BACKGROUND

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

Generally, conventional heat exchangers accomplish heat transfer from one fluid to another across a heat exchange surface. In plate type heat exchangers, fluids exchange heat while flowing through heat exchange zones between adjacent (stacked) peripherally sealed thin metal heat exchanger plates. Plate type heat exchangers offer the benefits of counter-current thermal contact, a large easily adjustable surface area-to-volume ratio, and relative compactness. Plate type heat exchangers are the most popular alternative to the more conventional shell-and-tube type heat exchangers for these reasons. Heat exchanger plates may be manufactured by pressing, embossing or other techniques known in the art to create long lengths of corrugated patterns and/or interleaving ridges forming plate paths, flow channels, and/or flow passages, wherein indirect heat exchange may take place between fluids disposed on either side of the ridges. These processes generally aim to produce a uniform, smooth, and defect-free flow passage. However, room for improvement exists in this technology and efficiencies may be increased.

Plate-Fin Heat Exchangers (PFHE), also known as Brazed Aluminum Heat Exchangers (BAHX), provide the ability to exchange large quantities of energy between numerous streams in a compact unit as compared to conventional shell-and-tube heat exchangers. The Aluminum Plate-Fin Heat Exchanger Manufacturers' Association (ALPEMA) Standard elaborates on their design, fabrication, shipping, and operation. The stream passages or layers of these PFHE may generally be comprised of sheets of mechanically formed metal. These sheets or layers take the shape of fins creating channels of substantially rectangular shape. According to ALPEMA, fin height (h), fin thickness (t), and fin pitch (density) (p) may generally vary within the following ranges depending on the service, the manufacturer, and or the desired operating characteristics: Fin Height: about 2.0 millimeter (mm) to about 12.0 mm; Fin Thickness: about 0.15 mm to about 0.70 mm; Fin Pitch: about 1.0 mm to about 4.5 mm. Additional characteristics are the percent perforation (% perf) and a length (lₛ) for either the length of the serration of a serrated fin or the distance between crests on herringbone fins. The distributors, the main fins, the end bars placed around the edge of the fins, are assembled piecemeal onto a solid partition plate. Each heat exchanger plate, sheet, or layer of flow passages may have representative dimensions of 600 mm in width and 1,500 mm in length. Multiple heat exchanger plates may be stacked and placed into a vacuum furnace, wherein the collection of these individual layers becomes one solid piece via a process called diffusion bonding. A representative depth of a final assembly or core may be 600 mm. Multiple assemblies or cores may be joined together to form a final heat exchanger unit.

The piecemeal assembly practice inherently creates intra-layer fluid communication and ineffective pressure drop between different fin sections, e.g., between inlet distributor to a first main fin section to a second main fin section to an outlet section. Additionally, the current manufacturing method of producing the distributor sections may not uniformly distribute the fluid from the inlet section to the main fin sections, e.g., diverting relatively more or relatively less fluid to certain channels. Similar issues may be present as the fluid is collected form the main fin sections to the outlet section. Many current distributor designs result in areas of inefficient heat transfer, or dead spaces, in corners (e.g., due to a lack of fluid flow) and/or may result in an increased pressure drop at the junctions between distributor sections and main fin sections (e.g., due to misalignment, gaps, etc.).

Additive manufacturing techniques are increasingly used in manufacturing. Typically, additive manufacturing techniques start from a digital representation of the object to be formed generated using a computer system and computer aided design and manufacturing (CAD/CAM) software. The digital representation may be digitally separated into a series of cross-sectional layers that may be stacked or aggregated to form the object as a whole. The additive manufacturing apparatus, e.g., a 3D printer, uses this data for building the object on a layer-by-layer basis. Additional background information is known in the art and may be found in U.S. Patent Applications 2014/0205454, 2014/0163717, 2014/0154088, 2014/0124483, 2013/0310961, 2013/0316183, and 2013/0149182, and European Patent Application 2675583, each of which is hereby incorporated by reference in their entirety.

### SUMMARY

This disclosure includes a heat exchanging apparatus, comprising a heat exchanger plate comprising a plurality of flow passages, and wherein each flow passage comprises at least one surface feature configured to change the flow characteristics of a linear flow along an axis of flow for the flow passage.

The disclosure further includes a method of constructing a heat exchanger, comprising using additive manufacturing to form a first plate having a plurality of flow passages, wherein each of the flow passages has one or more integral surface features, wherein the integral surface features are configured to change the flow characteristics of a fluid flowed linearly along an axis of flow for the flow passage.

The disclosure additionally includes a method of using a heat exchanging apparatus, comprising flowing a first fluid through a first flow passage, wherein flowing comprises passing the fluid along the first flow passage, disturbing a flow of the fluid using a plurality of surface features disposed at regular intervals along an axis of flow for the flow passage, wherein the plurality of surface features allow the flow of fluid to continue flowing along the axis of flow for the flow passage, and flowing a second fluid through a second flow passage, wherein heat is exchanged between the first fluid and the second fluid.

### BRIEF DESCRIPTION OF THE DRAWINGS

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles.

FIG. 1 is an exemplary exploded view of a conventional welded plate frame heat exchanger.

FIG. 2 is a perspective view of a conventional PFHE plate.

FIG. 3 is a perspective view of a plurality of conventional distributors.

FIG. 4 is a cross-sectional schematic of a conventional distributor.

FIG. 5 is an embodiment of a distributor in accordance with the present disclosure.

### DETAILED DESCRIPTION

Exemplary embodiments are described herein. However, to the extent that the following description is specific to a particular, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

The present technological advancement can capture technology opportunities through the use of additive manufacturing as a technique to change various operating characteristics for PFHE-type heat exchangers. The disclosed techniques may reduce or eliminate the piecemeal assembly practices that inherently create intra-layer fluid communication and ineffective pressure drop between different fin sections. The disclosed techniques may more uniformly distribute the fluid from the inlet section to the main fin sections. The disclosed techniques may improve the efficiency of heat transfer, and/or eliminate dead spaces, in corners (e.g., due to a lack of fluid flow), and reduce and/or prevent undesirable pressure drops at the junctions between distributor sections and main fin sections (e.g., due to misalignment, gaps, etc.). Moreover, the present disclosure accomplishes this technique as enabled by new and previously unavailable manufacturing capabilities that permit the present techniques to precisely control what variations are utilized at the inlets and/or outlets of channels within a precise tolerance, e.g., to within ±2 mm, ±1.5 mm, ±1 mm, ±0.75 mm, ±0.5 mm, ±0.25 mm, ±0.1 mm, ±0.05 mm, etc.

As used herein, the phrase “additive manufacturing” means a process of creating a three dimensional (3D) item of manufacture/equipment, where successive layers of material are laid down to form a three-dimensional structure. Exemplary 3D printing techniques include, but are not limited to, Scanning Laser Epitaxy (SLE), Selective Laser Sintering/Hot Isostatic Pressing (SLS/HIP), Fused Deposition Modeling, foil-based techniques, and direct metal laser sintering (DMLS).

As used herein, the phrase “aggregate flow” means a flowing fluid understood in its bulk entirety within the context of a flow passage and not viewed or analyzed in discrete, disaggregated portions or segments. For example, an aggregate flow may be described as generally having a single, horizontal direction of flow along an axis of flow for a flow passage while comprising discrete, lesser portions therein of eddy, turbulent, or other limited cross- or counter-directional flow with respect to the aggregate flow. A flow passage will have a single direction of aggregate flow along an axis of flow for that flow passage or portion thereof.

As used herein, the phrase “indirect heat exchange” means the bringing of two fluids into heat exchange relation without any physical contact or intermixing of the fluids with each other.

As used herein, the phrase “integrally formed” means constructed, fabricated, manufactured, printed, sintered, and/or machined such that the component is comprised of the same unitary material as the substrate. As used herein, the phrase “integrally formed” does not mean brazed, welded, embedded, bonded, or otherwise affixed or coupled as one component onto a second component, e.g., as with an inline valve, flow restrictor, baffle, etc. as conventionally installed along a flowpath. Integrally forming a structure on a substrate explicitly includes fabricating a component on a substrate by one or more additive manufacturing techniques. Integrally forming a structure on a substrate includes forming the component as a negative space, channel, depression, cavity, or other such space along the substrate. Integrally forming a structure on a substrate may occur at the same time as fabrication of the substrate.

As used herein, the phrase “flow passage profile” means the cross-sectional shape of the relevant flow passage. For example, flow passage profiles may be generally circular, triangular, oblong, rectangular, polygonal, etc., or any combination thereof.

As used herein, the phrase “flow passage wall” means any outer boundary of a given flow passage, including any applicable sides, floors, and/or ceilings for a given flow passage.

As used herein, the term “fluid” means gases, liquids, and combinations of gases and liquids, as well as to combinations of gases and solids, and combinations of liquids and solids.

As used herein, the term “substantial” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

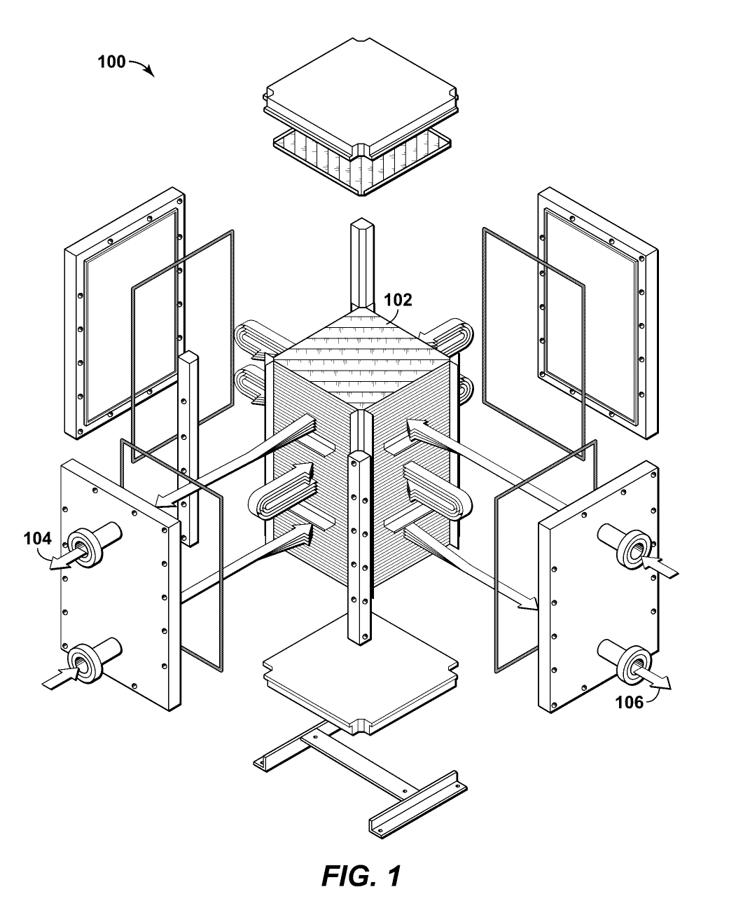

FIG. 1 is an exemplary exploded view of a conventional welded plate frame heat exchanger 100. Heat exchanger 100 (e.g., a plate frame exchanger (PFE)) includes a core 102 and various frame and housing components. The core 102 includes a plurality of metal plates that are configured to transfer heat between fluids 104 and 106. The metal plates are compressed together in a rigid frame to form an arrangement of parallel flow passages with alternating hot fluids 104 and cold fluids 106. The metal plates may be corrugated plates, e.g., having intermating and/or chevron corrugations, and the flow passages themselves may be strictly linear or may have a wavy, a zigzag, or other shape pressed into the plate.

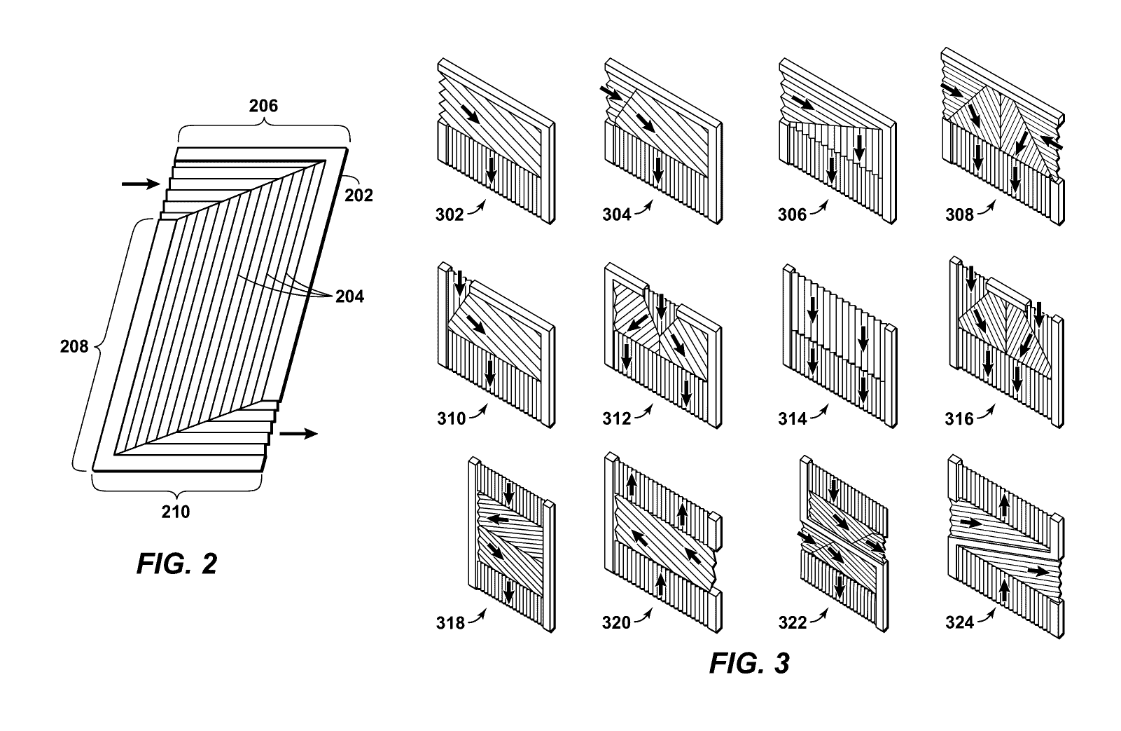

FIG. 2 is a perspective view of a conventional PFHE plate 202, e.g., the heat exchanger plate of core 102 of FIG. 1, having a plurality of flow passages 204 extending from an inlet section 206, along an intermediate section 208, and to an outlet section 210. The flow passages 204 are arranged in parallel and are substantially uniform along their respective axis of flow.

FIG. 3 is a perspective view of a plurality of conventional distributors 302-324, e.g., as may be disposed at an inlet section 206 of FIG. 2, each configured to divert, direct, or otherwise distribute flow into an inlet section of a flow plate, e.g., plate 202 of FIG. 2. A course or path of flow through each of the distributors 302-324 is illustrated by solid arrows. As depicted, in some instances a distributors 302-324 may distribute a comparatively narrow flow to a comparatively wide plate of flow passages, may distribute a flow from a comparatively lesser number of flow passages to a comparatively greater number of flow passages, may distribute a flow from a comparatively greater number of flow passages to a comparatively lesser number of flow passages, may distribute a flow from a first angular orientation to a second (or third or fourth or more) angular orientation, may join a first flow with a second (or third or fourth or more) flow, or any combination thereof. Various embodiments of these and other configurations known to those of skill in the art are considered within the scope of the techniques disclosed in the present disclosure.

FIG. 4 is a cross-sectional schematic of a conventional distributor 402, e.g., any of the plurality of distributors 302-324 of FIG. 3. The distributor 402 comprises a first distributor fin section 404, a second distributor fin section 406, a third distributor fin section 408, a first main fin section 410, and a second main fin section 412. Those of skill in the art will appreciate that more or fewer distributor fin sections and/or main fin sections may be utilized depending on the selected distributor and/or flow passage arrangement. Due to manufacturing constraints, the distributor 402 comprises intersection gaps 414 at the union of the fins in the first distributor fin section 404 and the second distributor fin section 406, intersection gaps 414 at the union of the fins in the second distributor fin section 406 and the first main fin section 410, and intersection gaps 414 at the union of the fins in the first main fin section 410 and the second main fin section 412. As described above, the intersection gaps 414 may be due to current manufacturing methods wherein fins are assembled in a piecemeal manner. The intersection gaps 414 may result in non-uniform flow distribution through the distributor 402, may result in ineffective or otherwise undesirable pressure drops between different fin sections, areas of ineffective heat transfer (e.g., at the second distributor fin section 406, wherein a low- or no-flow condition exists), or any combination thereof. Current manufacturing techniques do not permit the formation of curved fins having mechanically uniform surfaces across a heat exchanger plate, e.g., a substantially or completely transition-free length running from the first distributor fin section 404 through the second main fin section 412.

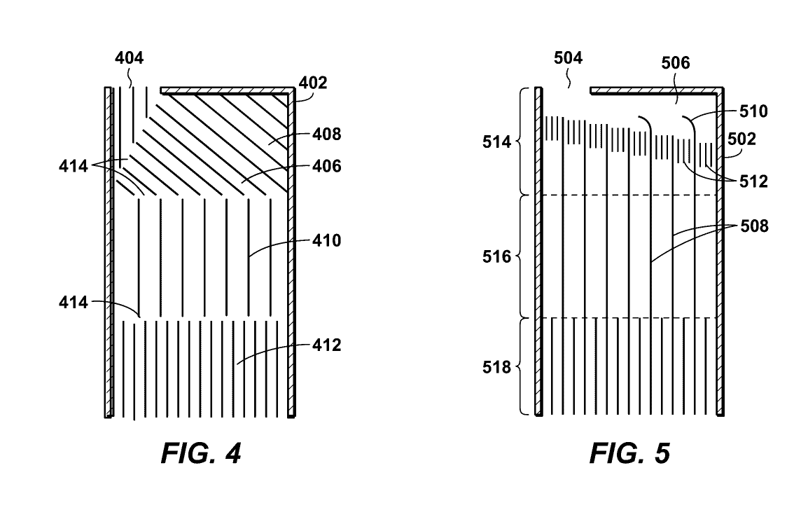

FIG. 5 is an embodiment of a distributor 502 in accordance with the present disclosure. The components of FIG. 5 may be substantially the same as the components of FIG. 4 except as otherwise noted. The distributor 502 has an inlet section 504 having an adjoining inlet plenum 506. While discussed separately, in some embodiments there is no distinction between the inlet section 504 and the inlet plenum 506. The distributor 502 comprises a plurality of main fins 508, at least a portion of which main fins 508 extend into the inlet plenum 506 as curved distributor fins 510. As depicted, the curved distributor fins 510 have substantially the same curvature; various embodiments include curved distributor fins 510 wherein at least one curved distributor fin has a curvature different than another curved distributor fin. In some embodiments, the curved distributor fins 510 may be integrally formed, e.g., by additive manufacturing, with respect to the heat exchanger plate comprising the substrate, with respect to the main fins 508, or with respect to both. In the depicted embodiment, the main fins 508 and the curved distributor fins 510 extend at differing lengths into the inlet plenum 506. The distributor 502 further comprises a plurality of flow guide fins 512 proximate to the inlet of the flow passages created by the main fins 508. The distributor 502 comprises a distributor fin section 514, a first main fin section 516, and a second main fin section 518. As depicted, the distributor 502 may be substantially gap-free with respect to intersection gaps. e.g., the intersection gaps 414 of FIG. 4, between the distributor fin section 514 and the first main fin section 516, between the first main fin section 516 and the second main fin section 518, or both.

Those of skill in the art will appreciate that the disclosed techniques include various embodiments. For example, in some embodiments one or more of the curved distributor fins 510 comprise a single curve, while other embodiments may comprise one or more curved distributor fins 510 having multiple curves and/or curvatures, one or more curves in conjunction with one or more intermediate straight sections, or any combination thereof. Additionally, various embodiments of the curved distributor fins 510 may include one or more curved distributor fins 510 having varying height, length, width, breadth, or any combination thereof. For example, some embodiments of the curved distributor fins 510 may include a lower portion that is narrower than a higher portion. Some embodiments of the curved distributor fins 510, the main fins 508, or a combination thereof may be shaped so as to create a non-polygonal flow passage, for example, a substantially cylindrical flow passage.

In contrast with the no-flow third distributor fin section 408 of FIG. 4, the distributor fin section 514 is configured to improve heat transfer and ensure flow (i.e., preclude a low- or no-flow condition) across the entirety of the distributor fin section 514.

The present techniques may be susceptible to various modifications and alternative forms, and the examples discussed above have been shown only by way of example. However, the present techniques are not intended to be limited to the particular examples disclosed herein. Indeed, the present techniques include all alternatives, modifications, and equivalents falling within the spirit and scope of the appended claims.

What is claimed is:

1. A heat exchanging apparatus, comprising:
a heat exchanger plate comprising a plurality of fins defining a plurality of flow passages for the heat exchanger plate, wherein at least one fin extends into an inlet section as a distributor fin, and wherein the distributor fin comprises a contiguous arm for directing flow from the inlet plenum into at least one flow passage.

2. The apparatus of claim 1, wherein the arm is integrally formed with respect to the at least one fin.

3. The apparatus of claim 1, wherein the arm is curved.

4. The apparatus of claim 1, wherein at least two fins extend into the inlet plenum as distributor fins.

5. The apparatus of claim 4, wherein each of the at least two fins have a curvature different than the curvature of the other fin.

6. The apparatus of claim 4, wherein the at least two fins are of differing length.

7. The apparatus of claim 1, further comprising at least one flow guide fin disposed at an inlet section of the flow passage, and wherein the length of the at least one flow guide fin is less than the length of the flow passage.

8. The apparatus of claim 7, wherein the flow guide fin does not extend into a main fin section of the heat exchanger plate.

9. The apparatus of claim 1, wherein the inlet section comprises an inlet plenum without any of the plurality of fins extending therein.

10. The apparatus of claim 1, wherein the inlet section comprises an inlet plenum having at least a portion of the plurality of fins extending to differing lengths therein.

11. A method of passing a fluid across a heat exchanger, comprising:
passing the fluid through a heat exchanger plate inlet;
passing the fluid from the heat exchanger inlet across a distributor fin, wherein passing the fluid across the distributor fin comprises changing a direction of flow for the fluid from a first direction to a second direction; and
passing the fluid from the distributor fin to a flow passage, wherein the flow passage is defined by at least one main fin flow passage wall, and wherein the transition from the distributor fin to the main fin flow passage wall is gapless.

12. The method of claim 11, further comprising:
passing the fluid into a flow guide fin section disposed at an inlet of the flow passage, wherein the flow guide fin section comprises a plurality of guide fins.

13. The method of claim 12, further comprising:
passing the fluid into a main fin section, wherein at least a portion of the plurality of guide fins do not extend into the main fin section.

14. The method of claim 13, wherein the distributor fin is integrally formed on an inlet end of the main fin.

15. The method of claim 11, wherein changing the direction of flow for the fluid from the first direction to the second direction comprises passing the fluid in a curved path.

16. A method of constructing a heat exchanger, comprising:
using additive manufacturing to form a heat exchanger plate, comprising:
a plurality of flow passages defined by a plurality of main fins; and
a distributor fin integrally formed on an inlet end of a main fin, wherein the distributor fin is curved.

17. The method of claim 16, further comprising a plurality of distributor fins each integrally formed on an inlet end of an associated main fin, wherein at least one distributor fin differs from another distributor fin in curvature, length, or both.

18. The method of claim 16, wherein the heat exchanger plate further comprises:
a plurality of flow guide fins in a flow guide fin section disposed proximate to the inlet end of the at least a portion of the main fins; and
a main fin section downstream of the flow guide fin section, wherein at least a portion of the flow guide fins do not extend into the main fin section.

19. The method of claim 16, wherein the distributor fin is disposed in an inlet plenum.

20. The method of claim 16, wherein the heat exchanger plate further comprises:
an inlet plenum; and
a plurality of distributor fins each integrally formed on associated inlet ends of at least a second portion of the main fins, wherein at least two of the plurality of distributor fins extend into the inlet plenum at different lengths, utilize different curvatures, or both.
